(19) United States
(12) Patent Application Publication
(10) Pub. No.: US 2009/0254542 A1
(43) Pub. Date: Oct. 8, 2009

(54) SEARCH METHODS AND SYSTEMS

(75) Inventor: Fang-Wei Kang, Taipei City (TW)

Correspondence Address: QUINTERO LAW OFFICE, PC, 2210 MAIN STREET, SUITE 200, SANTA MONICA, CA, 90405, US

(73) Assignee: MITAC INTERNATIONAL CORP., TAOYUAN (TW)

(21) Appl. No.: 12/352,555

(22) Filed: Jan. 12, 2009

(30) Foreign Application Priority Data
Apr. 7, 2008 (TW) TW97112497

(51) Int. Cl. G06F 17/30; G10L 15/04

(52) U.S. Cl. 707/5; 704/251; 704/E15.005; 707/E17.014; 707/E17.015; 707/E17.017

(57) ABSTRACT

Search methods and systems are provided. First, a voice is received. The voice is recognized using voice recognition technology to obtain at least two keywords, and a specific keyword combination is generated according to the keywords. A specific requirement among a plurality of requirements is associated according to the specific keyword combination, wherein each requirement corresponds to at least one of a plurality of keyword combinations. Then, according to the specific requirement, a database is searched to obtain at least candidate data conforming to the specific requirement.

### CROSS REFERENCE TO RELATED APPLICATIONS

This Application claims priority of Taiwan Patent Application No. 097112497, filed on Apr. 7, 2008, the entirety of which is incorporated by reference herein.

### BACKGROUND OF THE INVENTION

1. Field of the Invention

The disclosure relates generally to search methods and systems, and, more particularly to methods and systems that automatically recognize users' requirements to accordingly perform a search.

2. Description of the Related Art

Recently, wireless positioning technology, such as a GPS (Global Positioning System), has become a popular application for electronic devices, such as computers and portable devices. The GPS can receive signals from satellites, and accordingly determine the position of the electronic device. Users can also use navigation software in the electronic device for route planning and navigation.

The GPS can provide a convenient navigation capability. However, it is dangerous if users manually operate and manipulate related settings on the GPS while driving a car. Therefore, some GPS can provide voice input functions. Users can input and operate the GPS via voice, thus reducing required manual GPS operations.

Conventionally, the voice input function of GPSs or PDAs (Personal Digital Assistants) can only receive predefined voice inputs, and use the predefined voice inputs as keywords for search. Since the predefined voice inputs are limited and determined by the designers of the GPSs or PDAs, it is difficult for the search results to provide 100 percent user satisfaction.

When users can arbitrarily speak a sentence, and the GPSs or PDAs can automatically recognize users' requirements to accordingly perform a search, it is believed the system practicability will be enhanced. User satisfaction can be increased if more random voice inputs can be used to accordingly search for and determine GPS operations.

### BRIEF SUMMARY OF THE INVENTION

Search methods and systems are provided.

In an embodiment of a search method, a voice is received. The voice is recognized using voice recognition technology to obtain at least two keywords, and a specific keyword combination is generated according to the keywords. A specific requirement among a plurality of requirements is associated according to the specific keyword combination, wherein each requirement corresponds to at least one of a plurality of keyword combinations. Then, according to the specific requirement, a database is searched to obtain at least candidate data conforming to the specific requirement.

An embodiment of a search system comprises a reception unit, a storage unit, and a processing unit. The reception unit receives a voice. The storage unit comprises a plurality of keyword combinations, a plurality of requirements, and a plurality of candidate data, wherein each requirement corresponds to at least one of the keyword combinations. The processing unit recognizes the voice using voice recognition technology to obtain at least two keywords, and generates a specific keyword combination according to the keywords. The processing unit associates a specific requirement among the requirements according to the specific keyword combination, and searches for at least one of the candidate data conforming to the specific requirement according to the specific requirement.

Search methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a search system of the invention;

FIG. 2 is a schematic diagram illustrating an embodiment of a storage unit of the invention;

FIG. 3 is a schematic diagram illustrating an embodiment of a relationship among keywords, keyword combinations, and requirements of the invention;

FIG. 4 is a schematic diagram illustrating another embodiment of a relationship among keywords, keyword combinations, and requirements of the invention;

FIG. 5 is a flowchart of an embodiment of a search method of the invention; and

FIG. 6 is a flowchart of another embodiment of a search method of the invention.

### DETAILED DESCRIPTION OF THE INVENTION

Search methods and systems are provided.

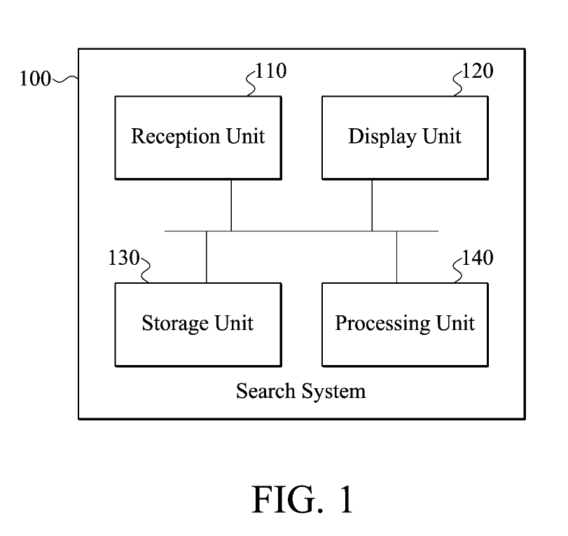

FIG. 1 is a schematic diagram illustrating an embodiment of a search system of the invention. The search system is suitable for use in an electronic device, such as a computer system or a portable device. In some embodiments, the portable device may have a navigation function.

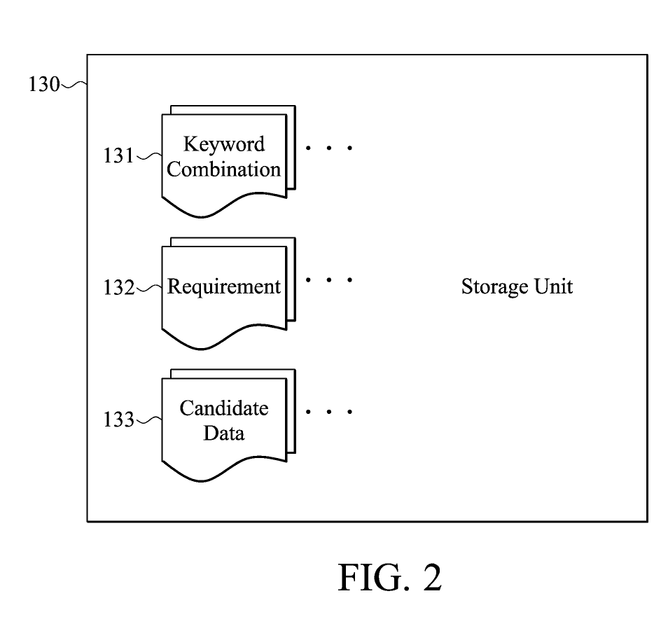

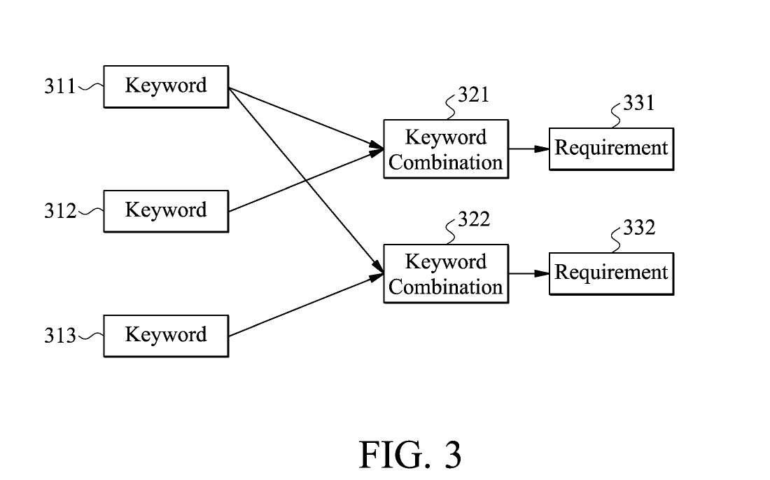

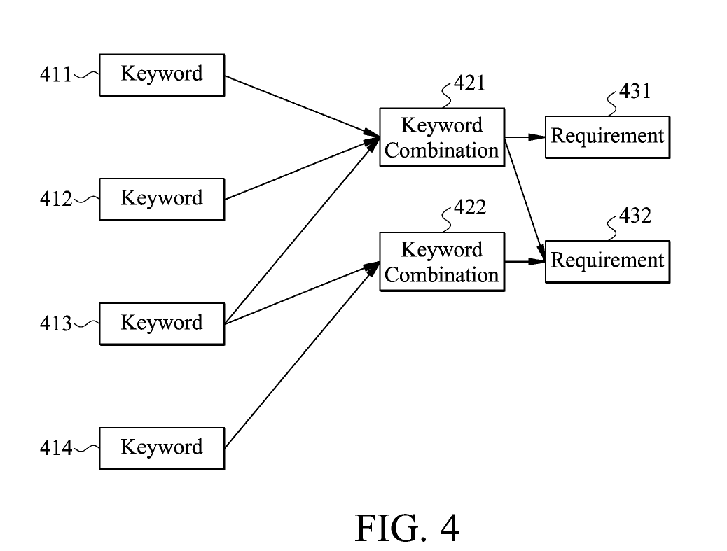

The search system 100 comprises a reception unit 110, a display unit 120, a storage unit 130, and a processing unit 140. The reception unit 110 receives voice inputs from users. The display unit 120 displays related data, such as user interfaces, route planning results, navigation information, and data being searched for. The storage unit 130 comprises a plurality of keyword combinations 131, a plurality of requirements 132, and a plurality of candidate data 133, as shown in FIG. 2. The candidate data 133 is data provided to search for. In some embodiments, the candidate data 133 may have respective attributes, such as names, properties, and/or classifications. In some embodiments, the candidate data 133 may have location data, such as records for addresses and/or longitude and latitude information. Each keyword combination 131 is composed of at least two keywords. Each keyword combination 131 corresponds to at least one requirement 132, and/or each requirement 132 corresponds to at least one of the keyword combinations 131. For example, FIG. 3 is a schematic diagram illustrating an embodiment of a relationship among keywords, keyword combinations, and requirements of the invention. In FIG. 3, the keyword combination 321 is composed of keywords 311 and 312, and the keyword combination 321 corresponds to requirement 331. The keyword combination 322 is composed of keywords 311 and 313, and the keyword combination 322 corresponds to a requirement 332. FIG. 4 is a schematic diagram illustrating another embodiment of a relationship among keywords, keyword combinations, and requirements of the invention. In FIG. 4, the keyword combination 421 is composed of keywords 411, 412 and 413, and the keyword combination 421 corresponds to requirements 431 and 432. The keyword combination 422 is composed of keywords 413 and 414, and the keyword combination 422 corresponds to a requirement 432. It is understood that, the relationship among keywords, keyword combinations, and requirements can be defined according to various requirements, and the application is not limited thereto. In some embodiments, the keyword combinations 131, the requirements 132, and the candidate data 133 can be constructed via a relational database. The processing unit 140 performs the search methods of the invention, and related detail is discussed later.

It is noted that, when the electronic device is a portable device having a navigation function, the storage unit 130 may further comprise map data corresponding to at least one specific region, such as a region or country. The map data can comprise doorplate addresses, landmarks, scenic spots, and/or roads and information thereof. Additionally, the processing unit 140 can be a navigation engine having a route planning capability. Uses can input navigation parameters, such as a starting point, a destination point, and/or a pass-through point via the user interface. The processing unit 140 performs route planning according to the navigation parameters to obtain a route planning result. Users can use the electronic device to navigate to the destination point according to the route planning result. It is noted that, the search system 100 can further comprise a signal reception unit (not shown) to receive satellite signals. The processing unit 140 can calculate a current position of the electronic device according to the received signals.

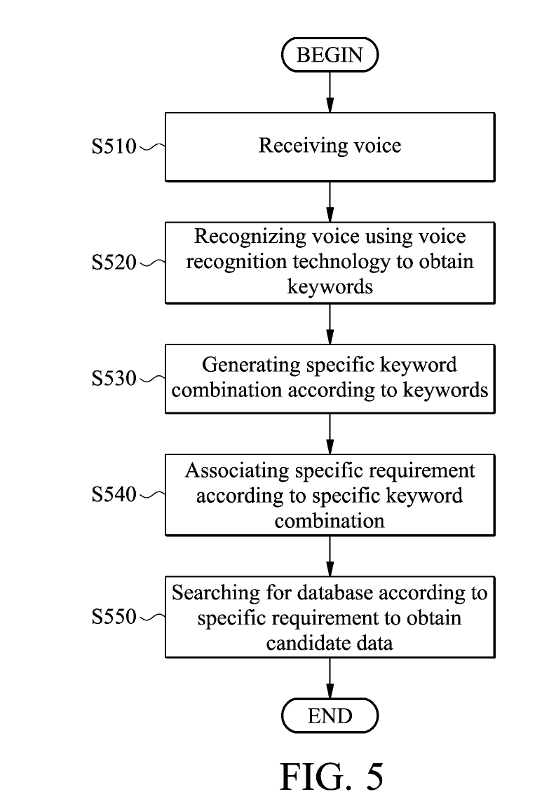

FIG. 5 is a flowchart of an embodiment of a search method of the invention. The search method is suitable for use in an electronic device.

In step S510, at least one voice is received. In step S520, the voice is recognized using voice recognition technology to obtain at least two keywords. In some embodiments, the voice recognition technology can divide the voice into several voice units, such as characters and/or words. Then, the characters and/or words are compared with a database to obtain the keywords. In step S530, a specific keyword combination is generated according to the keywords. In step S540, a specific requirement according to the specific keyword combination is associated. It is understood that, the relationships among keywords, keyword combinations, and requirements can be defined in advance, and each keyword combination corresponds to at least one requirement, and/or each requirement corresponds to at least one of the keyword combinations. Thereafter, in step S550, according to the specific requirement, a database is searched to obtain at least candidate data conforming to the specific requirement. It is noted that, the candidate data may have respective attributes. When the attributes of the candidate data conform to the specific requirement, the candidate data is retrieved.

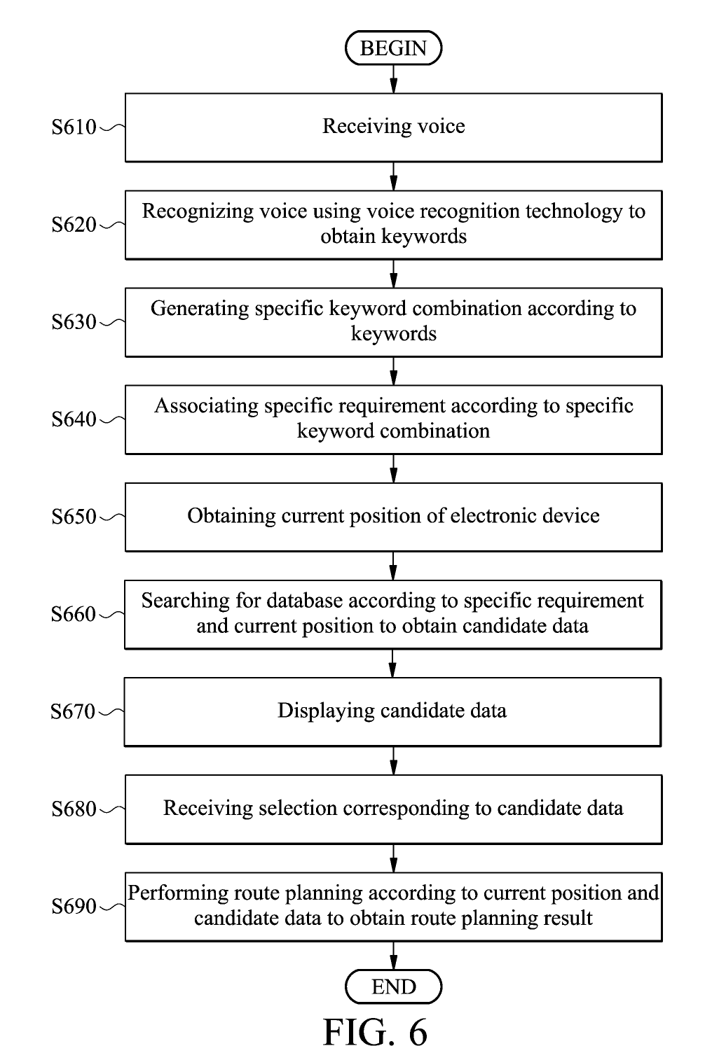

FIG. 6 is a flowchart of another embodiment of a search method of the invention. The search method is suitable for use in an electronic device having route planning and/or navigation capabilities.

In step S610, at least one voice is received. In step S620, the voice is recognized using voice recognition technology to obtain at least two keywords. Similarly, in some embodiments, the voice recognition technology can divide the voice into several voice units, such as characters and/or words. Then, the characters and/or words are compared with a database to obtain the keywords. In step S630, a specific keyword combination is generated according to the keywords. In step S640, a specific requirement according to the specific keyword combination is associated. Similarly, the relationships among keywords, keyword combinations, and requirements can be defined in advance, and each keyword combination corresponds to at least one requirement, and/or each requirement corresponds to at least one of the keyword combinations. Thereafter, in step S650, a current position of the electronic device is obtained. As described, the current position of the electronic device can be calculated according to the received satellite signals. In step S660, according to the specific requirement, a database is searched and the current position of the electronic device is determined to obtain at least candidate data conforming to the specific requirement. Similarly, the candidate data may have respective attributes. When the attributes of the candidate data conforms to the specific requirement, the candidate data is retrieved. It is understood that, in some embodiments, a predefined distance, such as 5 or 10 KM can be defined in the electronic device, and if so, the retrieved candidate data would be within the predefined distance of the current position of the electronic device. In step S670, the retrieved candidate data is displayed in the display unit 120. Then, in step S680, a selection corresponding to at least one of the candidate data is received. It is understood that, in some embodiments, the display unit 120 may be a touch-sensitive display unit. That is, users can directly perform related inputs and selections via the display unit 120. After the candidate data is selected, in step S690, the selected candidate data is set as a destination point or a pass-through point, and a route is planned according to the current position of the electronic device and the selected candidate data to obtain a route planning result. Users can use the electronic device to navigate to the candidate data according to the route planning result.

Following is an example. When an input voice is [symbol] two keywords [symbol] and [symbol] are obtained after the voice recognition. The keywords [symbol] and [symbol] are combined, and associated to a specific requirement [symbol] Then, related candidate data is searched for according to the specific requirement [symbol] Therefore, candidate data, such as restaurants, bakery and/or others can be retrieved. Additionally, when an input voice is [symbol] two keywords [symbol] and [symbol] are obtained after the voice recognition. The keywords [symbol] and [symbol] are combined, and associated to a specific requirement [symbol] Then, related candidate data is searched for according to the specific requirement [symbol] Therefore, candidate data, such as hospitals, and/or pharmacies can be retrieved. Further, when an input voice is [symbol] two keywords [symbol] and [symbol] are obtained after the voice recognition. The keywords [symbol] foot [symbol] and [symbol] are combined, and associated to specific requirements [symbol] and/or [symbol] Then, related candidate data is searched for according to the specific requirements [symbol] and/or [symbol] Therefore, candidate data, such as hospitals, pharmacies, foot massage shops, and/or traditional Thailand massage shops can be retrieved.

As described, each keyword combination can associate to at least one requirement. When a keyword combination is associated to several requirements, all associated requirements can be displayed. Users can select a specific requirement among the associated requirements in a manual or voice manner. For example, when an input voice is [symbol] two keywords [symbol] and [symbol] are obtained after the voice recognition. The keywords [symbol] and [symbol] are combined, and associated to specific requirements [symbol] [symbol] and [symbol] The associated requirements can be displayed. Users can select one of the associated requirements in a manual or voice manner, and related candidate data is searched for according to the selected requirement. It is understood that, in some embodiments, the search methods and systems of the application may have a learning capability to memorize the relationship between the keyword combination and the requirement selected by users. When the same keyword combination is generated again, related associated requirements can be automatically filtered. In some embodiments, only the requirement formerly selected by users is displayed. In some embodiments, the requirement formerly selected by users is displayed as the first item or highlighted among several requirements.

Therefore, the search methods and systems can automatically recognize users' requirements using voice recognition technology, thus to accordingly perform subsequent search and/or navigation procedures. With the search methods and systems of the application, practical usage can be enhanced, and user satisfaction can be increased.

Search methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A search method for use in an electronic device, comprising:
receiving at least one voice;
recognizing the voice using voice recognition technology to obtain at least two keywords;
generating a specific keyword combination according to the keywords;
associating a specific requirement among a plurality of requirements according to the specific keyword combination, wherein each requirement corresponds to at least one of a plurality of keyword combinations; and
searching a database according to the specific requirement to obtain at least candidate data conforming to the specific requirement.

2. The method of claim 1, further comprising:
obtaining a current position of the electronic device; and
searching the database according to the specific requirement to obtain the candidate data within a predefined distance of the current position.

3. The method of claim 1, further comprising displaying the candidate data.

4. The method of claim 1, further comprising:
selecting the candidate data;
obtaining a current position of the electronic device; and
planning a route according to the current position of the electronic device and the candidate data to obtain a route planning result.

5. The method of claim 4, wherein the candidate data comprises location data, and the electronic device sets the candidate data as a destination point or a pass-through point.

6. The method of claim 5, further comprising navigating to the candidate data according to the route planning result by the electronic device.

7. A search system for use in an electronic device, comprising:
a reception unit receiving at least one voice; and
a storage unit comprising a plurality of keyword combinations, a plurality of requirements, and a plurality of candidate data, wherein each requirement corresponds to at least one of the keyword combinations; and
a processing unit recognizing the voice using voice recognition technology to obtain at least two keywords, generating a specific keyword combination according to the keywords, associating a specific requirement among the requirements according to the specific keyword combination, and searching for at least one of the candidate conforming to the specific requirement according to the specific requirement.

8. The system of claim 7, wherein the processing unit further obtains a current position of the electronic device, and according to the specific requirement, searches the database to obtain the candidate data within a predefined distance of the current position.

9. The system of claim 7, wherein the processing unit further displays the candidate data in the display unit.

10. The system of claim 7, wherein the processing unit further receives a selection corresponding to the candidate data, obtains a current position of the electronic device, and plans a route according to the current position of the electronic device and the candidate data to obtain a route planning result.

11. The system of claim 10, wherein the candidate data comprises location data, and the processing unit sets the candidate data as a destination point or a pass-through point.

12. The system of claim 11, wherein the electronic device is navigated to the candidate data according to the route planning result.

13. A machine-readable storage medium comprising a computer program, which, when executed, causes a device to perform a search method, comprising:
receiving at least one voice;
recognizing the voice using voice recognition technology to obtain at least two keywords;
generating a specific keyword combination according to the keywords;
associating a specific requirement among a plurality of requirements according to the specific keyword combination, wherein each requirement corresponds to at least one of a plurality of keyword combinations; and
searching a database according to the specific requirement to obtain at least candidate data conforming to the specific requirement.
